(19) United States
(12) Patent Application Publication
(10) Pub. No.: US 2008/0219331 A1
(43) Pub. Date: Sep. 11, 2008

(54) Methods and apparatus for reducing the effects of DAC images in radio frequency transceivers

(75) Inventors: Paul Cheng-Po Liang, Santa Clara, CA (US); Richard H. Strandberg, Fremont, CA (US)

Correspondence Address: PATENT LAW PROFESSIONALS, P.O. BOX 612407, SAN JOSE, CA, 95161, US

(73) Assignee: Matsushita Electric Industrial Co., Ltd.

(21) Appl. No.: 11/715,539

(22) Filed: Mar. 7, 2007

(51) Int. Cl. H04L 5/16

(52) U.S. Cl. 375/219

(57) ABSTRACT

Methods and apparatus for reducing the effects of digital-to-analog converter (DAC) images and transmission spurious effects in a receive frequency band of a radio frequency (RF) transceiver. A transceiver apparatus includes a transmitter portion having a DAC, a receiver portion configured to receive RF signals in a receive frequency band, and a variable rate clock generator. The variable rate clock generator is used to provide an oversampling clock for the DAC. The rate of the oversampling clock is adjustable and is selected so that an upconverted version of a DAC image created by the DAC is steered away from frequencies within the receive frequency band. A notch-effect low-pass filter (NELPF) may also, or alternatively, be used in the transceiver to reduce transmission spurious effects in the receive frequency band.

### FIELD OF THE INVENTION

The present invention relates generally to digital communications systems. More specifically, the present invention relates to reducing noise in multi-mode and multi-band transceivers.

### BACKGROUND OF THE INVENTION

Wireless communication technologies have developed rapidly over the years, particularly since first generation (1G) mobile communications systems were introduced for public use in the early 1980s. In recent years, analog 1G systems have been superseded by second and third generation (2G and 3G) digital communications systems. Digital systems provide a number of benefits over analog systems including improved spectral efficiency, higher signal quality, enhanced security features (e.g., by way of digital encryption) and the ability to be manufactured in the form of Very Large Scale Integrated (VLSI) circuits.

The basic building blocks of any wireless communication device are the device's transmitter and receiver. In many applications the transmitter and receiver are designed so that they can share resources (e.g., antenna, clock and integrated circuit resources). When configured in this manner, they are collectively referred to as a “transceiver”.

FIG. 1 is a simplified block diagram of a typical radio frequency (RF) transceiver 100. The transceiver 100 comprises baseband circuitry and processing block 102, a transmitter portion 104, a receiver portion 106, a duplexer 108 and an antenna 110. The transmitter portion 104 of the transceiver 100 includes a digital-to-analog converter (DAC) 112, a first low-pass filter (LPF) 114, an upconverter 116 and a power amplifier (PA) 118. During operation, the baseband circuitry and processing block 102 provides a sequence of digital over-sampled signals to the DAC 112. The over-sampled signals are generated from binary input data received from a digital information source (not shown) and formatted in accordance with the applicable wireless communication standard. The DAC 112 converts the over-sampled signals into analog baseband signals. The analog baseband signals are filtered by the first LPF 114 and upconverted to RF by the upconverter 116. The upconverted RF signals are coupled to the drive input of the PA 118, which operates to amplify the upconverted RF signal and provide the resulting amplified RF signal to the antenna 110, via the duplexer 108.

The receiver portion 106 of the transceiver 100 includes a low noise amplifier (LNA) 120, a downconverter 122, a second LPF 124 and an analog-to-digital converter (ADC) 126. The LNA 120 receives RF signals from the antenna 10, via the duplexer 108, and amplifies the RF signals. The amplified RF signals are then downconverted from RF to baseband by the downconverter 122, filtered by the second LPF 124 and finally converted to digital baseband over-sampled signals by the ADC 126.

The duplexer 108 of the transceiver 100 comprises two band-pass filters with a common input port and two output ports. One of the filters is configured so that it is centered at the desired frequency band of the receiver portion 106 of the transceiver 100. It operates as a receiver preselection filter as well as providing a means for suppressing transmission power that tends to leak into the receiver portion 106. The other filter is employed as a transmitter filter to suppress out-of-transmission-band noise as well as spurious transmissions. The duplexer 108 is not needed in all applications. However, in full-duplex applications in which the transmitter and receiver portions 104, 106 operate at the same time (e.g., such as in a CDMA (code division multiple access) or in a UMTS (universal mobile telecommunications system) based communication system), the duplexer 108 is required so that the antenna 110 can be shared by both the transmitter and receiver portions 104, 106.

FIG. 2 is a simplified power spectral density (PSD) plot of an RF signal generated by the transmitter portion 104 of the transceiver 100. As shown, a desired frequency band 200 is centered around the RF carrier frequency, F_{c}. A spectral image 202 (or “DAC image) of the desired frequency band is also shown in the PSD plot at a frequency, F_{c}+F_{dac}, where F_{dac} represents the sampling frequency applied to the DAC. Although only a single DAC image 202 is shown in FIG. 2, DAC images are created at integer multiples of the sampling clock frequency, F_{dac}. In other words, DAC images are created at F_{c}+nF_{dac}, for every integer n. DAC images are well known byproducts of the sampling process. They are undesirable, however, since they contribute to noise, can desensitize the receiver portion 106 of the transceiver 100, and can make it difficult to comply with noise requirements specified by standards.

One conventional technique that can be used to reduce the effects of DAC images is to filter the output of the DAC 112 using an analog LPF such as the analog LPF 114 in FIG. 1. This approach is not very attractive, however, since the LPF must be a high-quality analog filter with a sharp cut-off frequency. Because an analog filter having such characteristics is difficult to design, and would be costly to manufacture, other approaches to removing DAC images have been sought.

Another technique for reducing the effects of DAC images involves using an “oversampling” DAC to implement the DAC 112. An oversampling DAC oversamples the symbol data appearing at the input of the DAC 112 using a clock having a higher sampling frequency than F_{dac}. A commonly-used oversampling DAC is the delta-sigma DAC (or “Σ-Δ DAC”), which uses a pulse density conversion technique to perform the digital-to-analog conversion. Oversampling has the effect of steering in-band noise away from lower frequencies of interest to higher frequencies of little interest. This “noise-shaping” characteristic of the sigma-delta DAC is beneficial since it allows a simpler and less expensive analog low-pass filter 114 to be used.

While oversampling can be used to steer DAC images away from a receive band in some applications, in other applications such as, for example, multi-band or multi-mode applications, it cannot. Multi-band and multi-mode transceivers are required to transmit and receive at various frequency bands and/or transmit and receive at the same time. FIG. 3 shows, for example, the bands of operation and frequency separations between the transmit (Tx) and receive (Rx) bands for transceivers operating according to the 3GPP UTRA/FDD (Third Generation Partnership Project UMTS Terrestrial Radio Access Frequency Division Duplexing) standard. As can be seen, a transceiver configured to operation according to the UTRA/FDD standard is operable to transmit and receive signals in any one of the several operating bands (i.e., operating bands I-VII). The frequency separation between the transmit (Tx) carrier frequency and the center frequency of the various receive (Rx) band is different for each operating band.

In practice it is not uncommon for a DAC image of a transmitted signal to fall within the vicinity of a Rx band. Consider, for example, a signal in a UTRA/FDD system having a symbol rate of 3.84 MHz and an oversampling factor of fourteen (14×). As shown in FIG. 4, which is a plot of the power spectral density (PSD) measured at the output of the PA 118 of the transmitter portion 104 at a 100 kHz resolution bandwidth. A DAC image (frequencies normalized to baseband) 400 resides around 3.84 MHz×14=53.76 MHz. Unfortunately, this image 400 is very close to the 45 MHz separation between the Tx and Rx frequency bands when the receiver portion 106 is configured to operate in operating bands V or VI (see table in FIG. 3). More specifically, the DAC image 400 has a value of approximately −50 dBm at 45 MHz from the carrier frequency for a 100 kHz measurement bandwidth. This translates to power density of approximately −150 dBm/Hz at the input of the receiver portion 106 (i.e., at the input of the LNA 120), with the assumption of a −50 dBm attenuation contribution by isolation components and the duplexer 108. Unfortunately, −150 dBm/Hz is much higher than the maximum allowable noise power density specified by the UTRA/FDD standard. The receiver portion 106 of the transceiver is severely desensitized as a consequence. While the DAC image 400 would be less of a problem during times when the receiver portion 106 is configured to operate in frequency band I, an oversampling DAC clock set to a fixed rate cannot properly shift DAC images away from the various receive bands for all Tx-Rx operating band combinations.

It would be desirable, therefore, to have methods and apparatus for reducing the effects of DAC images and other transmission spurious effects in the receive bands of multi-band and multi-mode transceivers.

### SUMMARY OF THE INVENTION

Methods and apparatus for reducing the effects of digital-to-analog converter (DAC) images and transmission spurious effects in a receive frequency band of a radio frequency (RF) transceiver are disclosed. An exemplary transceiver apparatus includes a transmitter portion having a digital signal processing block that accomplishes data rate conversion and a DAC; a receiver portion configured to receive RF signals in a receive frequency band; and a variable rate clock generator. The variable rate clock generator and digital signal processing block are used to provide oversampled clock and data for the DAC. The rate of the oversampled clock and data is adjustable and is selected so that an upconverted version of a DAC image created by the DAC is steered away from frequencies within the receive frequency band. In multi-mode or multi-band applications the rate of the oversampled clock and data can be adjusted so that DAC images do not fall within other receive frequency bands of interest. Among other benefits, shifting DAC images away from receive frequency bands of interest reduces desensitization of the receiver portion of the transceiver, and helps to ensure that specified receive noise requirements are satisfied. FIG. 6 shows the new output PSD shifted DAC image 606 that was accomplished by increasing the DAC clock frequency and increasing digital rate conversion by a factor of “m”. This new output PSD provides greater signal attenuation in the band of interest 604.

In addition to, or as an alternative to the DAC image shifting apparatus and methods, a digital low-pass filter that operates as a notch filter (i.e. a notch-effect low-pass filter (NELPF)) is used in the transceiver. According this aspect of the invention the notch frequency of the NELPF may be controlled by the same variable rate oversampling clock that is used by the DAC in the transmitter portion of the transceiver. The variable rate clocking provided by the variable rate clock generator thereby allows the notch frequency to be placed at frequency where a desired receive frequency band is located. In this manner undesirable transmission energy can be significantly reduced in bands of interest.

Other features and advantages of the present invention will be understood upon reading and understanding the detailed description of the preferred exemplary embodiments, found hereinbelow, in conjunction with reference to the drawings, a brief description of which are provided below.

### BRIEF DESCRIPTION OF THE DRAWINGS

FIG. 1 is a block diagram of a typical prior art radio frequency (RF) transceiver;

FIG. 2 is a simplified power spectral density (PSD) plot of an RF signal generated by the transmitter portion of the transceiver in FIG. 1;

FIG. 3 is a table showing the bands of operation and frequency separations between the transmit (Tx) and receive (Rx) bands for transceivers operating according to the 3GPP UTRA/FDD standard;

FIG. 4 is a PSD plot illustrating how a DAC image undesirably overlaps with a receive frequency band and, therefore, has the effect of desensitizing the receiver portion of a transceiver configured to operate according to the 3GPP UTRA/FDD standard;

FIG. 5 is a block diagram of an RF transceiver employing a variable rate oversampling clock generator and a digital signal processing block for data rate conversion, according to an embodiment of the present invention;

FIG. 6 is a simplified PSD plot illustrating how a DAC image generated by the DAC in the RF transceiver in FIG. 5 is shifted away from a receive frequency band of interest by using a variable rate oversampling clock, in accordance with an embodiment of the present invention;

FIG. 7 is a representation of a look-up table (LUT) that stores values of the oversampling factor m for different operating bands associated with a single wireless communication standard and/or for different operating bands associated with various wireless communication standards;

FIG. 8 is a PSD plot illustrating how a DAC image generated by the DAC in the RF transceiver in FIG. 5 is shifted away from a receive frequency band of interest by using a variable rate oversampling clock, when the transceiver is configured to operate according to the 3GPP UTRA/FDD standard;

FIG. 9 is a frequency response plot of a digital low-pass filter that illustrates how the digital low-pass filter functions as a notch filter with a notch frequency centered at one-half the sampling frequency;

FIG. 10 is a block diagram of an RF transceiver that utilizes a notch-effect low-pass filter (NELFP), in addition to employing an adjustable rate conversion block, according to an embodiment of the present invention;

FIG. 11 is a simplified PSD plot illustrating how a NELPF can be used to reduce transmission spurious effects in a desired receive frequency band, in accordance with an embodiment of the present invention;

FIG. 12 is a PSD plot illustrating how a variable rate oversampling clock and a NELPF can be used to reduce undesirable transmission energy in a desired receive frequency band, when the transceiver in FIG. 10 is configured to operate according to the 3GPP UTRA/FDD standard;

FIG. 13 is a block diagram of the transmitter portion of a polar modulation transceiver, in which a variable rate conversion block and variable rate clock generator are used to reduce the effects of DAC images in a desired receive frequency band, according to an embodiment of the present invention; and

FIG. 14 is a block diagram of the transmitter portion of a polar modulation transceiver, in which NELPF is used to suppress noise in a receive frequency band of interest, in addition to employing an adjustable rate conversion block to shift a DAC image away from the receive frequency band of interest, according to an embodiment of the present invention.

### DETAILED DESCRIPTION

Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

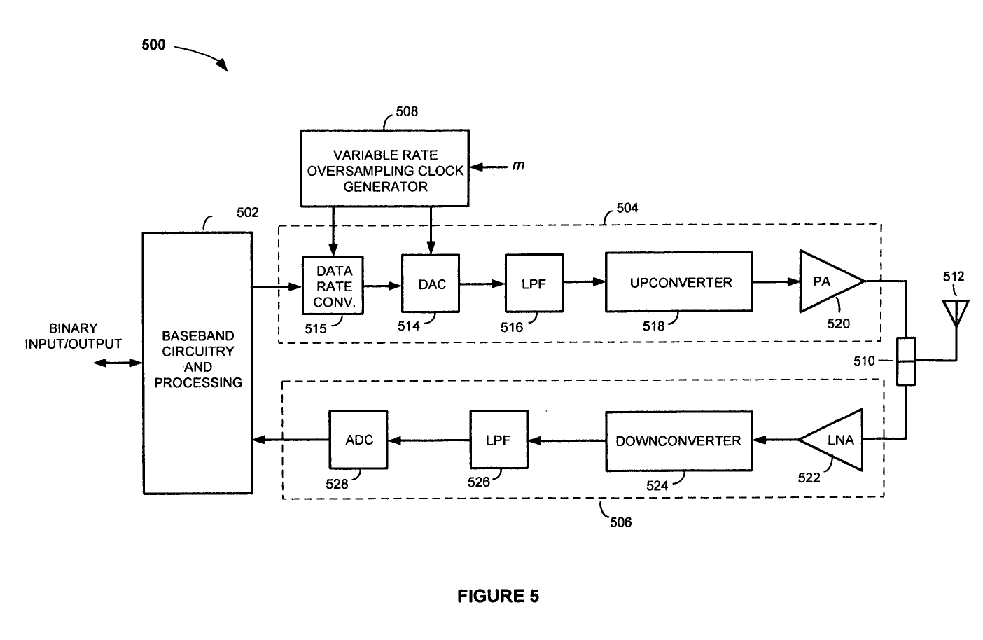

FIG. 5 shows an RF transceiver 500 according to an embodiment of the present invention. The transceiver 500 comprises baseband circuit and processing block 502, a transmitter portion 504, a receiver portion 506, a variable rate (i.e., adjustable) oversampling clock generator 508, a duplexer 510 and an antenna 512. The transmitter portion 504 of the transceiver 500 includes a data rate conversion block 515, a digital-to-analog converter (DAC) 514, a first low-pass filter (LPF) 516, an upconverter 518 and a power amplifier (PA) 520. The receiver portion 506 receives and downconverts RF signals to baseband for processing similar to that described above. During transmission, the baseband circuitry and processing block 502 provides a sequence of digital data to the data rate conversion block. The digital data is processed according to the variable rate clock generator 508 and is converted by the DAC 514 into analog baseband signals according to a variable rate oversampling clock provided by the variable rate oversampling clock generator 508. The analog baseband signals are then filtered by the first LPF 516 and upconverted to RF by the upconverter 518. Finally, the upconverted RF signals are coupled to the drive input of the PA 520, which amplifies the signals and couples the resulting amplified RF signals to the antenna 512, via the duplexer 510.

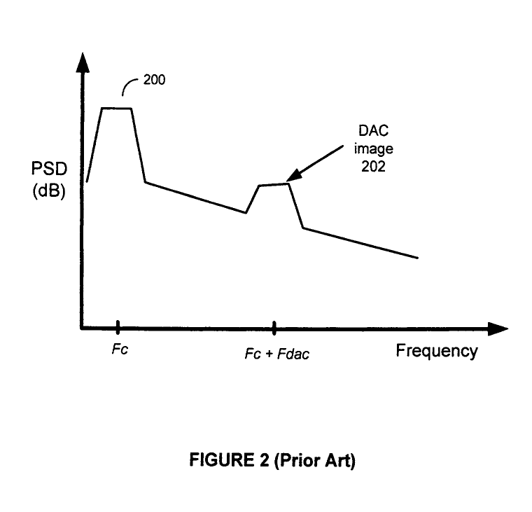

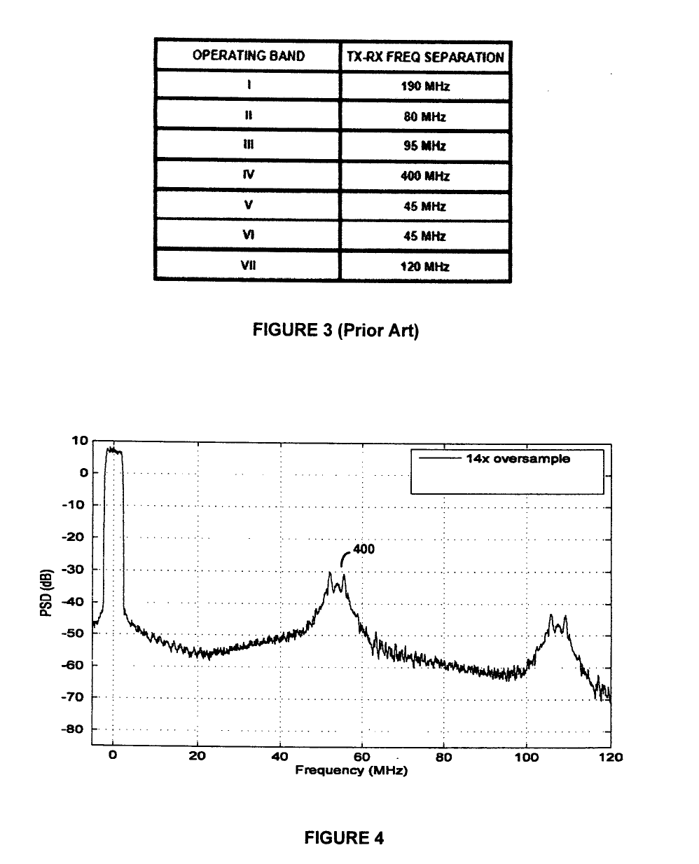

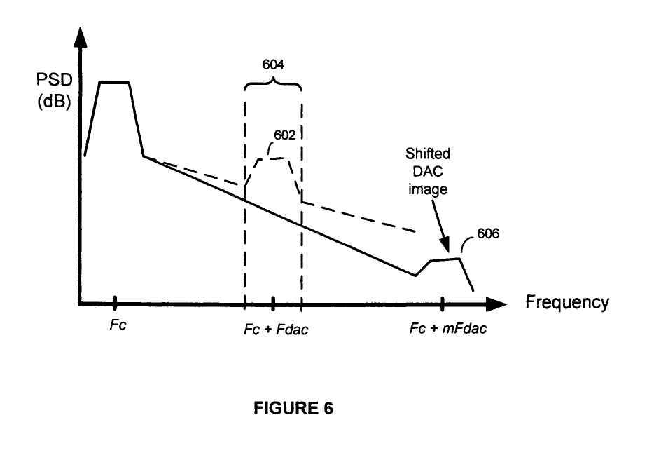

According to an embodiment of the invention, the transceiver 500 is configured as a multi-band or multi-mode transceiver capable of transmitting and receiving at different frequency bands for a given wireless standard and/or capable of transmitting and receiving at different modes defined by different wireless standards. To prevent desensitization of the receiver portion 506 of the transceiver 500, the variable rate oversampling clock generator 508 is configured to provide an oversampling clock having a rate that can be adjusted. The noise improvement achieved by virtue of this aspect of the invention is more clearly illustrated in FIG. 6. The dashed curve in FIG. 6 represents the PSD at the output of the transmitter portion 504 when the DAC 514 is being clocked at a set clock rate of F_{dac}, similar to that described above in FIG. 2. At this set clock rate, a DAC image 602 falls within a desired Rx band 604 of interest. As explained above, the DAC image 602 has the effect of desensitizing the receiver portion 506 of the transceiver 500, thereby making it difficult or impossible to satisfy the Rx noise requirements for all receive bands.

To avoid this problem, the variable rate oversampling clock generator 508 and the data rate conversion block 515 of the transceiver 500 are configured so that it provides an oversampling clock and rate-converted data having a rate dependent upon an oversampling factor m, where m is any positive integer or non-integer factor. The data rate conversion block 515 can be as simple as an interpolator. For each receive frequency band for which the receiver portion 506 is configured, the oversampling factor m is adjusted so that the DAC image created by the DAC 514 is shifted outside the receive frequency band. The oversampling factor m can be adjusted whenever the receiver portion 506 is reconfigured to receive in a different frequency band of interest, thereby ensuring that DAC images never fall within any given receive frequency band of interest.

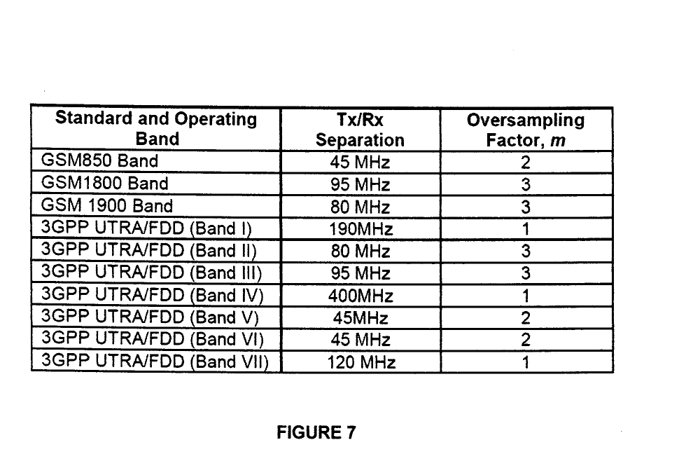

In accordance with embodiments of the invention, a look-up table (LUT) 700 is used to store values of the oversampling factor m for different operating bands associated with a single wireless communication standard and/or for different operating bands associated with multiple wireless communication standards. FIG. 7 illustrates, for example, a LUT 700 storing various values of the oversampling factor m for the 850 MHz, 1800 MHz and 1900 MHz operating bands of the Global System for Mobile Communications (GSM) wireless communication standard, and various values of the oversampling factor m for the various operating bands of the UTRA/FDD standard. The LUT 700 may be embodied in the form of hardware (e.g., using a state machine or logic circuitry formed on one the integrated circuit chips used to implement the rest of the transceiver 500) or may be embodied in the form of firmware or software instructions that are executable by a processing element of the transceiver 500, as will be understood by those of ordinary skill in the art.

The value of m provided to the oversampling clock generator 508 is determined by the operating band the transceiver 500 is currently configured to operate in. For example, when the transceiver 500 is configured to operate in the 850 MHz operating band, an oversampling of m=2 is provided by the LUT 700 to the clock generator 508. As shown in the table in FIG. 7, the Tx and Rx bands in the 850 MHz operating band are separated by 45 MHz. With a symbol rate of 3.84 MHz, an oversampling ratio of 14×, and an applied oversampling factor m=2 provided by the LUT 700, the DAC image frequency is shifted to a frequency of 3.84 MHz×14×2=107.52 MHz, which is a frequency that is far away from the Rx band.

If the transceiver 500 is subsequently reconfigured for operation in a different operating band, say, for example, the 1800 MHz GSM band, the oversampling factor m is adjusted to m=3 by accessing the entry in the LUT 700 that corresponds to the new operating band. In this case the oversampling factor is adjusted from a value of m=2 to a value of m=3, to shift the DAC image to 3.84 MHz×14×3=161.28 MHz away from the Rx band frequency, which is centered around 95 MHz.

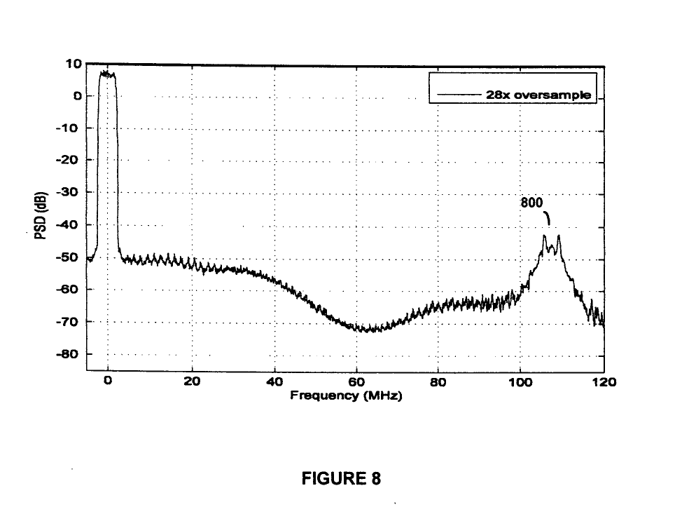

The effect of providing a variable rate oversampling clock generator and the data rate conversion block 515 can be further illustrated by considering an example where the transceiver 500 is configured to operate according to the 3GPP UTRA/FDD standard. As discussed in the prior art example above (see FIG. 4), for a symbol rate of 3.84 MHz and a fixed oversampling factor of 14×, a DAC image is generated which overlaps with the category V and VI receive frequency bands. FIG. 8 is a PSD plot illustrating how adjusting the oversampling factor to m=2, to provide an oversampling clock rate of 28× (rather than remaining at a fixed oversampling rate of 14×) has the effect of shifting the DAC image to a frequency greater than 100 MHz away from the carrier frequency. The shifted DAC image 800 is well above the category V and VI receive bands, which as shown in the table in FIG. 7 are centered at 45 MHz from the Tx carrier frequency. Those of ordinary skill in the art will readily appreciate and understand that the oversampling factor m can be similarly readjusted to avoid DAC images overlapping with other receive frequency bands of interest. For example, when the receiver portion 506 is configured to receive in operating band I, the oversampling factor can be set to m=1, so that the variable rate oversampling clock generator 508 provides an oversampling clock rate of 14×. Because the frequency separation between the Tx and Rx bands is 190 MHz (see table in FIG. 7), and the DAC image at an oversampling clock rate of 14× is at 53.76 MHz when configured in this manner, the shifted DAC image does not overlap with the receive frequency band.

Depending on the application and/or the wireless standard being used, shifting the DAC image using the variable rate oversampling clock generator 508, although helpful, may still be insufficient to reduce the Rx noise in a desired Rx band of interest to below a specified value. The Rx noise requirement according to some standards can, in fact, be very stringent. By way of example, consider a 3GPP UTRA/FDD transceiver system in which a maximum allowable noise power density at the front end of the receiver is required to be less than −174 dBm/Hz, assuming a 50 dBm attenuation contribution by the duplexer 510. Given these conditions, it can be shown that the maximum allowable noise power at the output of the PA 520 is −74 dBm in a 100 kHz measurement bandwidth. This threshold would be exceeded in the example above (see FIG. 8) since the output power at 45 MHz away from the carrier is at about −60 dBm in a 100 kHz measurement bandwidth.

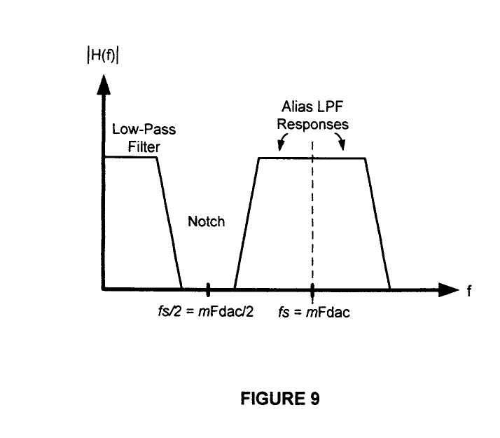

According to an embodiment of the invention, transmission spurious effects and/or other undesirable energy in the vicinity of a receive operating band can be further reduced, or reduced in an alternative manner, using a notch-effect low-pass filter (NELPF). According to sampling theory, a digital LPF only operates up to fₛ/2, where fₛ is the oversampling frequency. Alias ‘replica’ responses of the LPF appear about the oversampling frequency fₛ and its harmonics. For this reason, and as illustrated in FIG. 9, the digital LPF functions as a notch filter when observed across the broad analog domain bandwidth.

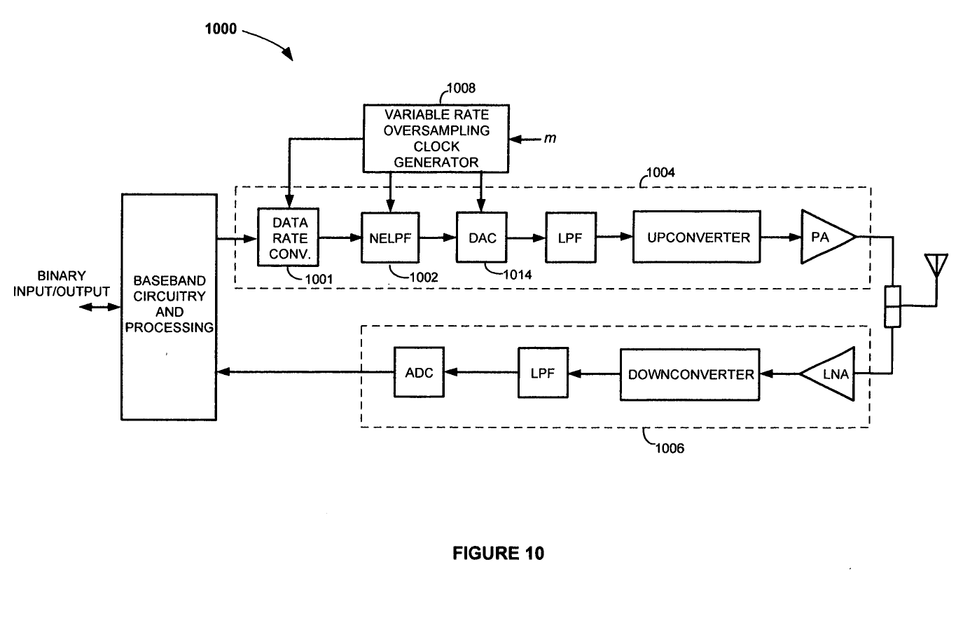

FIG. 10 is a block diagram of a transceiver 1000 that employs a digital signal processing data rate conversion block 1001 and a NELPF 1002 to further reduce transmission spurious effects (e.g., caused by DAC images), according to an embodiment of the present invention. Although shown as a separate element in FIG. 10, in an alternative embodiment the functionality of the digital signal processing data rate conversion block 1001 is merged with the NELPF 1002. The transceiver 1000 operates similar to the transceiver 500 above, except for the addition of the NELPF 1002 which has a notch that is centered at fₛ/2=mF_{dac}/2. The NELPF 1002 is shown as being clocked by the same oversampling clock fₛ=mF_{dac} as is used to clock the DAC 1014. However, in alternative embodiments it may be clocked by a different clock of the same or different frequency to place the notch at a preferred frequency. Further, the NELPF 1002 cut-off frequency can be designed to affect the width of the notch. A lower cut-off frequency results in a wider notch, while a higher cut-off frequency results in a narrower notch.

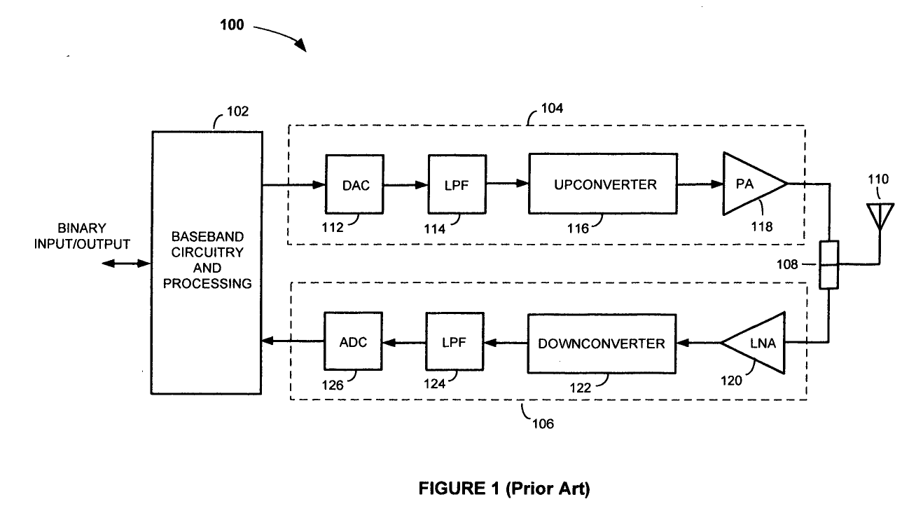

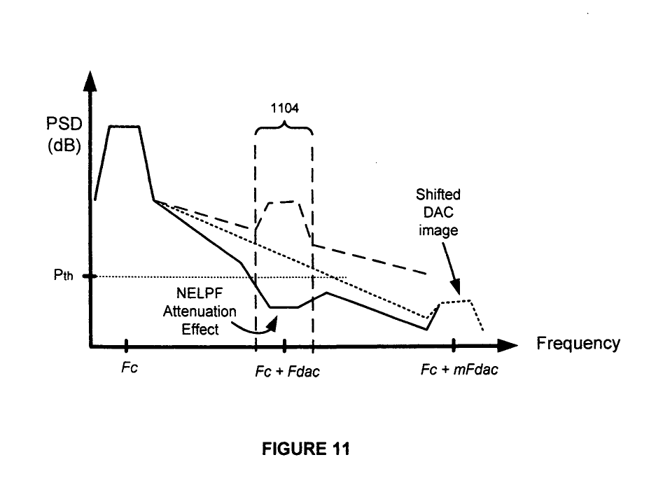

FIG. 11 is a PSD plot illustrating the effect of including the NELPF 1002 in the transmitter portion 1004 of the transceiver 1000. The dashed curve is the PSD at the output of the transmitter portion 104 when a fixed rate clock is used to clock the DAC 112 and no NELPF is employed (similar to as was discussed in connection with FIGS. 1 and 2 above). The dotted curve is the PSD at the output of the transmitter portion 504 when the data rate conversion block 515 is used, the variable rate oversampling clock generator 508 is used to clock the DAC 514, and no NELPF is employed (similar to as was discussed above in connection with FIGS. 5, 6 and 8). The solid curve is the PSD at the output of the transmitter portion 1004 when both a variable rate oversampling clock generator 1008 and the NELPF 1002 are used to reduce the effect of the DAC image created by the DAC 1014, as in FIG. 10. In addition to shifting the DAC image to a higher frequency by operation of the variable rate oversampling clock, the NELPF 1002 attenuates transmission spurious effects having frequencies falling within the receive frequency band 1104 to below a specified noise power threshold Pₜₕ.

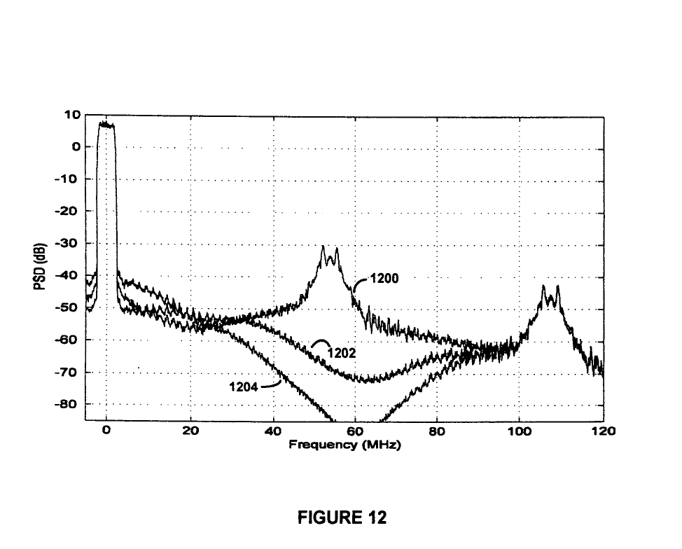

The effects of the NELPF 1002 are further illustrated in the FIG. 12, which compares measured PSD at the output of the transceiver portion of the transceivers shown in FIGS. 1, 5 and 10, when the transceivers are configured to operate according to the 3GPP UTRA/FDD standard. PSD curve 1200 includes a DAC image that resides around (53.76 MHz receive operating bands V and VI (45 MHz from carrier), when the UMTS transmit signal is oversampled by a factor of fourteen (14). PSD curve 1202 illustrates how variable rate oversampling clock generator 508 can be used to generate an oversampling clock having an oversampling factor of twenty-eight (28) which has the effect of shifting the DAC image away from the receive operating bands V and VI. Finally, PSD curve 1204 shows how the NELPF 1002 can be used to further attenuate transmission spurious effects in the vicinity of the receive operating bands V and VI. At 45 MHz away from the carrier, it is seen that the NELPF 902 has attenuated the in-band receive noise to about −75 dBm per 100 kHz measurement bandwidth, which is a value that satisfies the maximum allowable noise power level at the output of the PA 920 of −74 dBm per 100 kHz measurement bandwidth.

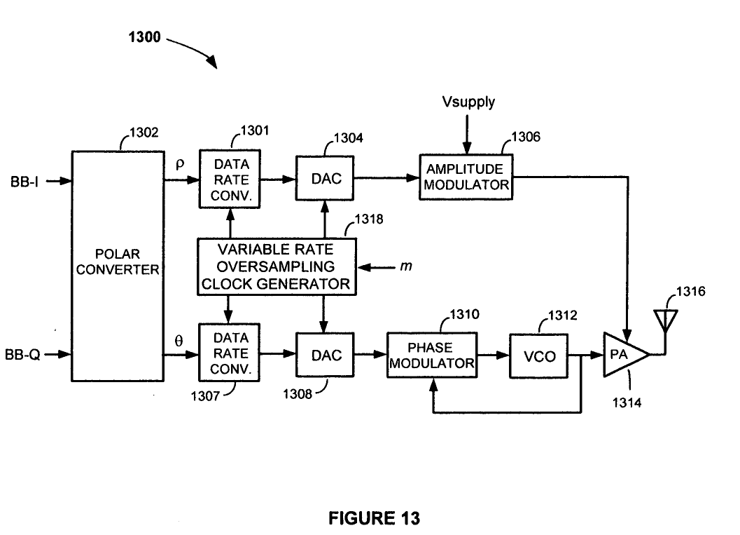

The variable rate oversampling clock generator 508 and/or the NELPF 1002 is not limited to being configured in any particular transceiver type. FIG. 13 shows, for example, how a variable rate oversampling clock generator can be used to reduce the effects of DAC images in a polar modulation transceiver, according to an embodiment of the present invention. For ease in illustration, only the transmitter portion 1300 is shown in the drawing. The transmitter portion 1300 includes a rectangular-to-polar converter 1302; a magnitude path that includes a first data rate conversion block 1301, a first DAC 1304 and an amplitude modulator 1306; a phase path that includes a second data rate conversion block 1307, a second DAC 1308, a phase modulator 1310 and VCO 1312; a PA 1314; an antenna 1316; and a variable rate oversampling clock generator 1318.

In operation, the polar converter 1302 receives in-phase baseband data (BB-I) and quadrature baseband data (BB-Q) and converts the baseband data to the polar domain, which is expressed in terms of magnitude and phase. The first DAC 1304 receives the magnitude information from the first data rate converter 1301 in the magnitude path and converts the digital magnitude signals into analog magnitude signals at an oversampling rate specified by the variable rate oversampling clock generator 1318. The amplitude modulator 1306 receives the converted analog magnitude signals and uses them to modulate a power supply voltage (Vsupply).

The second DAC 1308 receives phase information from the second data rate converter block 1307 in the phase path and converts the digital phase signals into analog constant amplitude phase signals at an oversampling rate specified by the variable rate oversampling clock generator 1318. The phase modulator 1310 and VCO 1312 operate to upconvert the analog constant amplitude phase signals to RF. The upconverted constant amplitude phase signals are used to drive the PA 1314 according to the amplitude modulated supply voltage applied to a power input port of the PA 1314.

Similar to the exemplary transceiver 500 in FIG. 5, the variable rate oversampling clock generator 1318 of the transmitter portion 1300 is configured so that it provides an oversampling clock having an oversampling factor m, where m is any positive integer or non-integer factor. For each receive frequency band for which the receiver portion is configured, the oversampling factor m is adjusted so that DAC images created by the first and second DACs 1304, 1308 are shifted outside the receive frequency band.

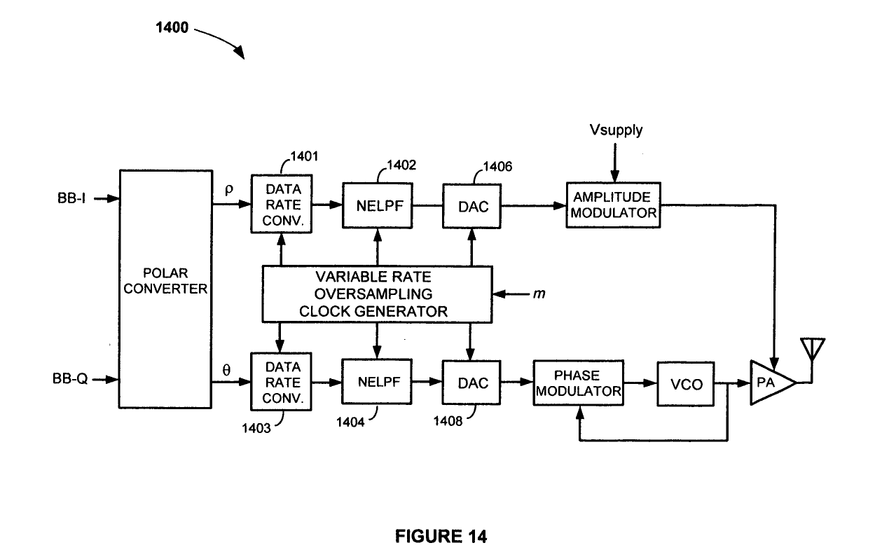

FIG. 14 illustrates how transmission spurious effects and/or other undesirable energy in the vicinity of a receive operating band can be further reduced, or reduced in an alternative manner, using first and second data rate converters 1401 and 1403 and first and second notch-effect low-pass filters (NELPFs) 1402 and 1404 in the transmitter portion 1400 of a polar modulation transceiver. The transmitter portion 1400 operates similar to the transmitter portion 1300 in FIG. 13, except for the addition of the first and second NELPFs 1402, 1404, which have notches centered at fₛ/2=mF_{dac}/2. The first and second NELPFs 1402, 1404 are shown as being clocked by the same oversampling clock fₛ=mF_{dac} as is used to clock the first and second DACs 1406, 1408. However, they may be alternatively clocked by a different clock of the same or different frequency to place the notches at preferred frequencies. Further, the cut-off frequencies of the first and second NELPFs 1402, 1404 can be designed to affect the widths of the notches. Lower cut-off frequencies result in wider notches, while higher cut-off frequencies result in narrower notches.

Although the present invention has been described with reference to specific embodiments thereof, these embodiments are merely illustrative, and not restrictive, of the present invention. For example, while shifting DAC images away from a desired Rx band, and/or use of a NELPF have been described in the context of satisfying the Rx noise requirement of a transceiver, these aspects of the invention may be used for other purposes. Further, while some of the exemplary embodiments have been described in the context of a multi-band transceiver operating according to the GSM and 3GPP UTRA/FDD standards, the inventions described herein are also applicable to other multi-band and multi-mode transceiver applications and/or standards. Hence, various modifications or changes to the specifically disclosed exemplary embodiments will be suggested to persons skilled in the art and are to be included within the spirit and purview of this application and scope of the appended claims.

What is claimed is:

1. A transceiver, comprising:
a transmitter portion including a digital-to-analog converter (DAC);
a receiver portion configured to receive RF signals in a receive frequency band; and
a variable rate clock generator operable to control said DAC,
wherein the rate of a variable rate clock provided by the variable rate clock generator is adjustable so that an upconverted version of a DAC image created by said DAC is shifted in frequency away from frequencies within said receive frequency band.

2. The transceiver of claim 1, further comprising a data rate converter configured to receive digital data and provide rate converted digital data to said DAC.

3. The transceiver of claim 2 wherein the data rate converter provides said rate converted data to said DAC according to the variable rate clock provided by the variable rate clock generator.

4. The transceiver of claim 1 wherein the transmitter portion further includes a digital filter that functions as a notch filter, said digital filter configured so that its notch frequency falls within the receive frequency band.

5. The transceiver of claim 4 wherein the digital filter is controlled by the variable rate clock provided by the variable rate clock generator.

6. The transceiver of claim 4, further comprising a data rate converter configured to receive digital data and provide rate converted digital data to said DAC.

7. The transceiver of claim 6 wherein the data rate converter provides said rate converted data according to the variable rate clock provided by the variable rate clock generator.

8. The transceiver of claim 6 wherein the functionality of the data rate converter is merged with the functionality of the digital filter.

9. A method of processing signals in a transceiver, comprising:
receiving a digital baseband signal from a digital source;
converting the digital baseband signal to an analog baseband signal according to an adjustable oversampling clock; and
upconverting the analog baseband signal to a radio frequency (RF) signal,
wherein converting the digital baseband signal to an analog baseband signal includes adjusting the rate of the adjustable oversampling clock so that an image created by the conversion process does not fall within a receive frequency band when the image is upconverted to RF by the upconversion process.

10. The method of claim 9, further comprising filtering the digital baseband signal using a digital low-pass filter that functions as a notch filter.

11. The method of claim 10 wherein a notch frequency of said the digital low-pass filter is configured so that it falls within the receive frequency band.

12. The method of claim 11 wherein the notch frequency of the digital low-pass filter is controlled by the adjustable oversampling clock.

13. A transceiver capable of transmitting and receiving in different transmit and frequency bands, comprising:
a polar modulation transmitter having a magnitude path and a phase path, at least one of said magnitude and phase paths having a digital-to-analog converter (DAC) configured to receive digital baseband signals from a digital source;
a receiver that can be configured to receive radio frequency (RF) signals in any one of several possible receive frequency bands; and
an oversampling clock generator operable to provide an oversampling clock to a clock input of said DAC, wherein the oversampling clock provided by the oversampling clock generator is adjustable so that a DAC image created by the DAC and upconverted to RF is shifted away from the receive frequency band in which the receiver is configured to receive.

14. The transceiver of claim 13 wherein at least one of said magnitude and phase paths of said transmitter includes a digital filter that operates as a notch filter.

15. The transceiver of claim 14 wherein the digital filter is configured so that its notch frequency falls within the frequency band in which the receiver is configured to receive.

16. The transceiver of claim 14 wherein the digital filter is controlled by the variable rate oversampling clock provided by the oversampling clock generator.

17. A mobile communication device, comprising:
baseband circuitry operable to generate digital symbols;
a transmitter having a digital-to-analog converter (DAC) that is operable to convert the digital symbols to analog signals;
a receiver configured to receive RF signals in one or more receive frequency bands; and
means for frequency shifting an upconverted version of a DAC image created by the DAC to a frequency region that does not substantially overlap with a receive frequency band in which the receiver is configured to receive.

18. The mobile communication device of claim 17 wherein said means for shifting a DAC image is configured to frequency shift the DAC image by an amount that depends on which one of said one or more receive frequency bands the receiver is configured to receive.

19. The mobile communication device of claim 18 wherein the transmitter further comprises a digital filter configured to filter the digital symbols, said digital filter having an adjustable notch frequency.

20. The mobile communication device of claim 19 wherein the digital filter is controlled by a sampling clock provided by the means for frequency shifting a DAC image.

21. A transceiver, comprising:
a transmitter portion including a digital-to-analog converter (DAC);
a receiver portion configured to receive RF signals in a receive frequency band; and
a variable rate clock generator operable to control said DAC,
wherein the rate of a variable rate clock provided by the variable rate clock generator is determined based on an operating band of a standard the transceiver is currently configured to operate in.
